(19) United States
(12) Patent Application Publication
(10) Pub. No.: US 2014/0078560 A1
(43) Pub. Date: Mar. 20, 2014

(54) TILT ADJUSTMENT MECHANISM, IMAGE CAPTURING UNIT DEVICE, IMAGE SCANNING DEVICE, IMAGE READING DEVICE, AND COPIER

(71) Applicants: Yoshiaki NAGAO, Kanagawa (JP); Tatsuaki NAGANO, Kanagawa (JP); Shohei SHINKAWA, Tokyo (JP); Masatoshi ISHIDA, Kanagawa (JP); Atsushi SUGAI, Kanagawa (JP)

(72) Inventors: Yoshiaki NAGAO, Kanagawa (JP); Tatsuaki NAGANO, Kanagawa (JP); Shohei SHINKAWA, Tokyo (JP); Masatoshi ISHIDA, Kanagawa (JP); Atsushi SUGAI, Kanagawa (JP)

(73) Assignee: RICOH COMPANY, LIMITED, Ohta-Ku, Tokyo (JP)

(21) Appl. No.: 14/014,632

(22) Filed: Aug. 30, 2013

(30) Foreign Application Priority Data
Sep. 14, 2012 (JP) 2012-202936

(51) Int. Cl. H04N 1/024

(52) U.S. Cl. CPC H04N 1/02481
USPC 358/474

(57) ABSTRACT

A tilt adjustment mechanism that is installed in an optical device that captures an image by using an image capturing unit part in which an image capturing sensor to capture an image and an imaging lens to image an image on the image capturing sensor are mounted on a holding member to constitute a unit part, the tilt adjustment mechanism is configured to adjust tilt of the image capturing unit part by rotating the image capturing unit part about the center of the imaging lens.

### CROSS-REFERENCE TO RELATED APPLICATIONS

The present application claims priority to and incorporates by reference the entire contents of Japanese Patent Application No. 2012-202936 filed in Japan on Sep. 14, 2012.

### BACKGROUND OF THE INVENTION

1. Field of the Invention

The present invention relates to a tilt adjustment mechanism that adjusts tilt in an image capturing unit part in which an image capturing sensor and an imaging lens are mounted on a holding member to constitute a unit part. The present invention also relates to an image capturing unit device, an image scanning device, an image reading device, and a copier to which the tilt adjustment mechanism is installed.

2. Description of the Related Art

A conventional image capturing unit part is known as described in Japanese Patent No. 3939908. FIG. 1 is a perspective view illustrating an image capturing unit part described in Japanese Patent No. 3939908. This image capturing unit part 900 holds a first lens group (not illustrated), a second lens 902, and an image capturing sensor 903 in a holder 901 that is a holding member. The first lens group is held by a first lens group holding part 901a in the holder 901. The first lens group holding part 901a has three grooves of an arch shape that are arranged in the optical axis direction. Although three lenses in the first lens group are not illustrated in FIG. 1 for the convenience of explanation, three lenses are fitted with the respective three grooves in the first lens group holding part 901a. At the downstream of the first lens group, the second lens 902 composed of a long concave lens and the image capturing sensor 903 are arranged in this order in the light travelling direction. Combination of the first lens group and the second lens 902 serves as an imaging lens for imaging an image on the surface of the image capturing sensor 903.

In recent years, techniques have been developed in which an optical system having a remarkably short focal length is available. With the techniques, several types of lenses and the image capturing sensor 903 can be configured as a unit part by assembling them in the holder 901 as illustrated in FIG. 1.

When the image capturing unit part 900 thus configured is installed in an optical device such as a scanner, positioning and tilt correction of the image capturing unit part 900 in the optical device are required before the image capturing unit part is installed to the optical device. The installation thus involves many operation processes.

For example, as illustrated in FIG. 2, assume that the image capturing unit part 900 is to be positioned in a position defined by the dotted line. In FIG. 2, the image capturing unit part 900 is in a position far from the position defied by the dotted line. First, an operator moves the image capturing unit part 900 to the position illustrated in FIG. 3 in the direction of the arrow in FIG. 2 on the x-v plane that is perpendicular to the optical axis of the lens. In general, the center point of the lens is the reference point in the positioning of the image capturing unit part 900, and the image capturing unit part 900 is moved so that the center point of the lens thereof is positioned in target coordinates. Then, the image capturing unit part 900 is rotated in the direction of the arrow in FIG. 3 to correct tilt.

Assume that, in this tilt correction, a tilt adjustment mechanism is used that has the same configuration as the configuration of a mechanism that have been conventionally and commonly used for lens tilt correction. Specifically, the tilt adjustment mechanism includes a supporting member (not illustrated) that supports the image capturing unit part 900 and has two elongate holes at both ends thereof in the longitudinal direction of the long lens. Two bolts that are screwed through the respective elongate holes into female screws in the main body of the optical device. Assume that tilt in the image capturing unit part is corrected by loosening these two bolts in the tilt adjustment mechanism and moving the supporting member within the clearances defined by the bolts and the inner walls of the elongate holes manually. In this operation, the supporting member can move in any direction on the x-y plane such as in the width direction and diagonal directions as well as in the longitudinal direction of the elongate holes because the width of the elongate holes is larger than that of the bolts. It is difficult to precisely adjust the direction in which the supporting member moves by way of manual operation. When the supporting member is rotated on the x-y plane to correct tilt, it frequently happens that the supporting member in whole is slightly moved in the x direction or the y direction, and as a result, the center point of the lens of the image capturing unit part 900 is deviated from the target coordinates. After the tilt correction, it ends up in deviation of the image capturing unit 900 in whole from the target position as illustrated in FIG. 5. Consequently, the image capturing unit part 900 needs to be moved again in the direction of the arrows in FIG. 5 on the x-y plane to the target position.

As described above, when the image capturing unit part 900 is installed to an optical device such as a scanner, at least three operation processes are required that are the positioning, tilt correction, and re-positioning of the image capturing unit part 900.

In view of the above-described background, there is needed to provide the following tilt adjustment mechanism and an image capturing unit device, an image scanning device, an image reading device, and a copier to which the tilt adjustment mechanism is installed. The tilt adjustment mechanism and the devices to which the tilt adjustment mechanism is installed facilitate the assembling procedure of the image capturing unit part compared with the conventional procedure.

### SUMMARY OF THE INVENTION

It is an object of the present invention to at least partially solve the problems in the conventional technology.

According to the present invention, there is provided: a tilt adjustment mechanism that is installed in an optical device that captures an image by using an image capturing unit part in which an image capturing sensor to capture an image and an imaging lens to image an image on the image capturing sensor are mounted on a holding member to constitute a unit part, and that is configured to adjust tilt of the image capturing unit part by rotating the image capturing unit part about the center of the imaging lens.

The present invention also provides an image capturing unit device comprising: an image capturing unit part in which an image capturing sensor to capture an image and an imaging lens to image an image on the image capturing sensor are mounted on a holding member to constitute a unit part; and a tilt adjustment mechanism configured to adjust tilt of the image capturing unit part by rotating the image capturing unit part about the center of the imaging lens.

The present invention also provides an image scanning device that scans an image on a document for reading the image, the image scanning device comprising: a light source configured to irradiate an image surface on the document with emitted light thereof; an image capturing unit part in which an image capturing sensor to capture an image and an imaging lens to image an image on the image capturing sensor are mounted on a holding member to constitute a unit part, and a tilt adjustment mechanism configured to adjust tilt of the image capturing unit part by rotating the image capturing unit part about the center of the imaging lens.

The present invention also provides an image reading device that reads an image on a document by using an image scanning unit that scans the image on the document and a document holding unit that holds the document at an image scanning position in the image scanning unit, wherein the above-mentioned image scanning device is used as the image scanning unit.

And, the present invention also provides a copier that includes an image reading unit configured to read an image on a document, and an image forming unit configured to form an image on a recording member, and the copier forms the image read by the image reading unit on the recording member by using the image forming unit and copies the image, wherein the above-mentioned image reading device is used as the image reading unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view illustrating an image capturing unit part described in Japanese Patent No. 3939908;

FIG. 2 is a schematic diagram for explaining a first operation process of a conventional method for positioning an image capturing unit part;

FIG. 3 is a schematic diagram for explaining a second operation process of the conventional method for positioning an image capturing unit part;

FIG. 4 is a schematic diagram for explaining a state of the image capturing unit part immediately after the second operation process;

FIG. 5 is a schematic diagram for explaining a third operation process of the conventional method for positioning an image capturing unit part;

FIG. 6 is a perspective view illustrating a copier according to an embodiment of the present invention;

FIG. 7 is a schematic configuration diagram illustrating the copier according to the embodiment;

FIG. 8 is an enlarged configuration diagram illustrating an image forming unit for Y in the copier;

FIG. 9 is a perspective view illustrating a scanner of the copier;

FIG. 10 is an exploded perspective view illustrating the scanner;

FIG. 11 is an enlarged configuration diagram illustrating an integrated scanning unit in the scanner in an enlarged scale;

FIG. 12 is an enlarged configuration diagram illustrating an image capturing unit device;

FIG. 13 is a front view illustrating a first lens group and a supporting plate of an image capturing unit part;

FIG. 14 is a front view of the image capturing unit device;

FIG. 15 is a plan view illustrating the image capturing unit device;

FIG. 16 is a front view illustrating the image capturing unit device in a tilt adjustment process; and

FIG. 17 is a front view illustrating an image capturing unit device in an example of the copier.

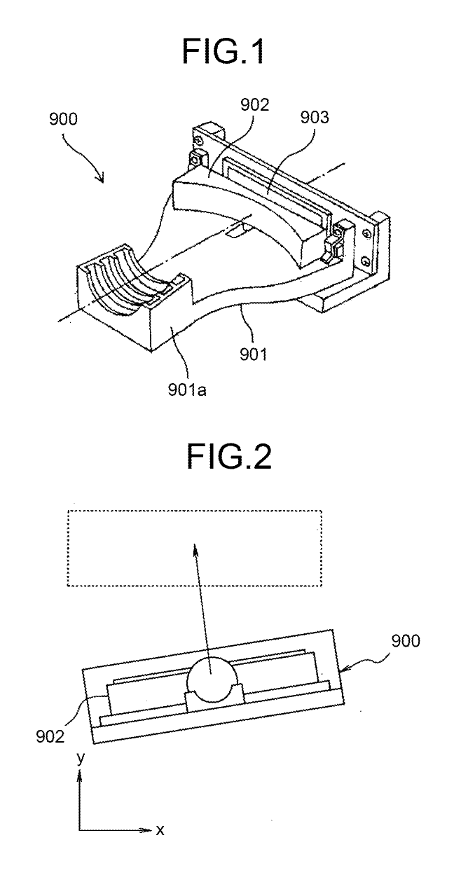

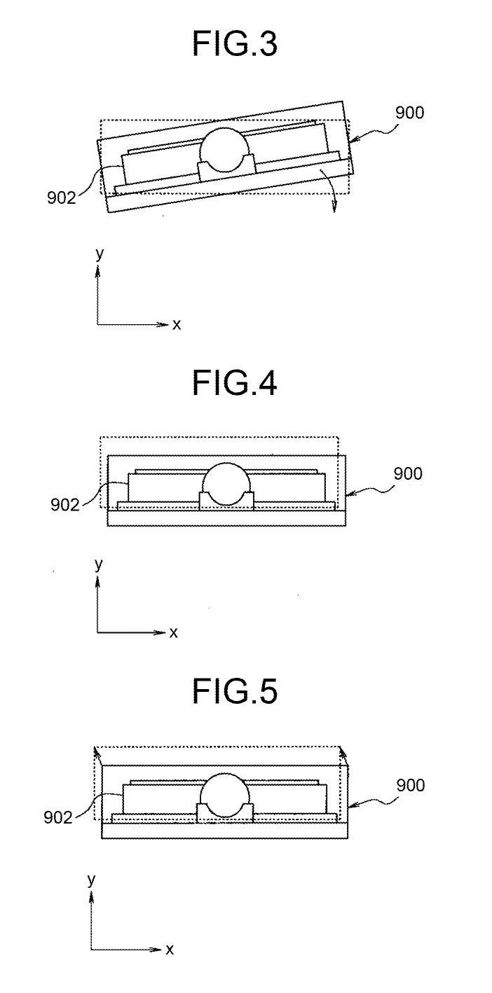

### DETAILED DESCRIPTION OF THE PREFERRED EMBODIMENT

Described below is an exemplary embodiment of the present invention that is applied to an electrophotographic copier (hereinafter simply called a copier).

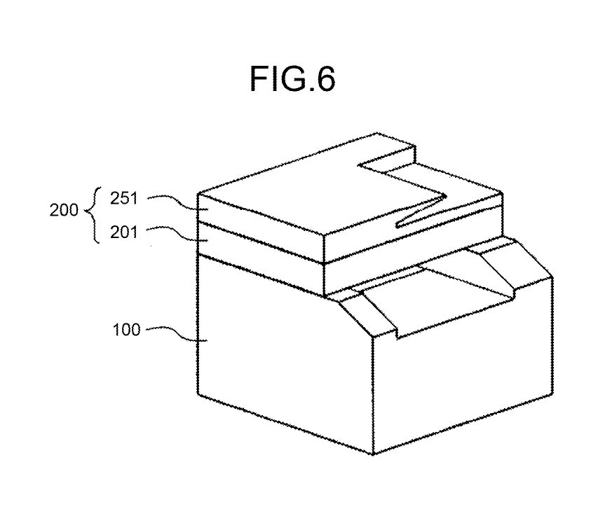

A basic configuration of the copier according to the embodiment will be described. FIG. 6 is a perspective view illustrating the copier according to the embodiment. This copier includes a printer 100 and an image reading unit 200. The image reading unit 200 includes a scanner 201 fixed on the top of the printer 100 and an automatic document feeder (ADF) 251 supported by the scanner 201.

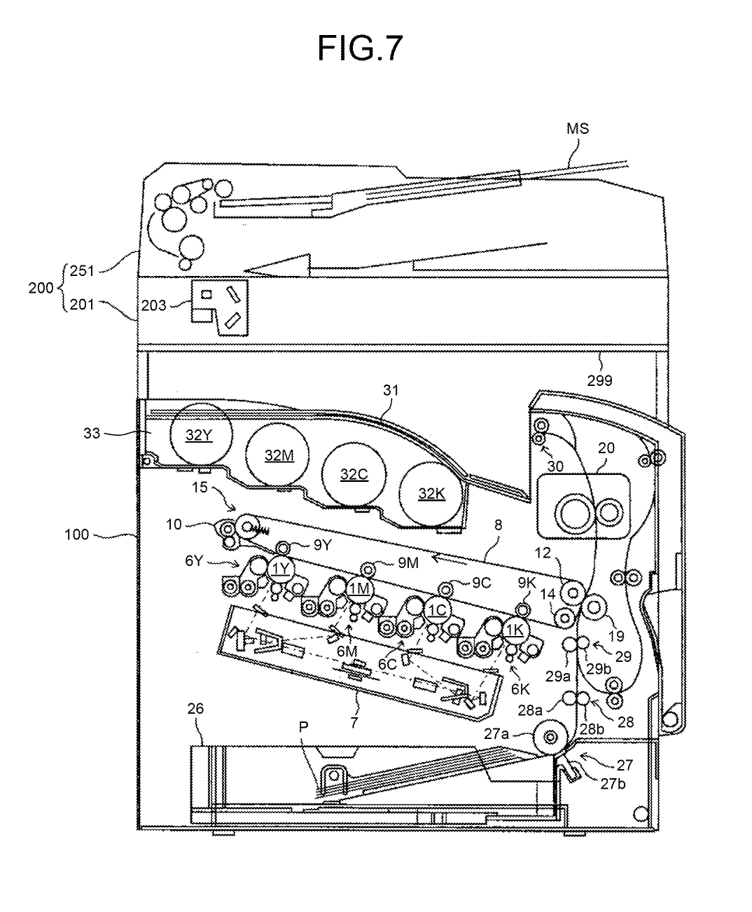

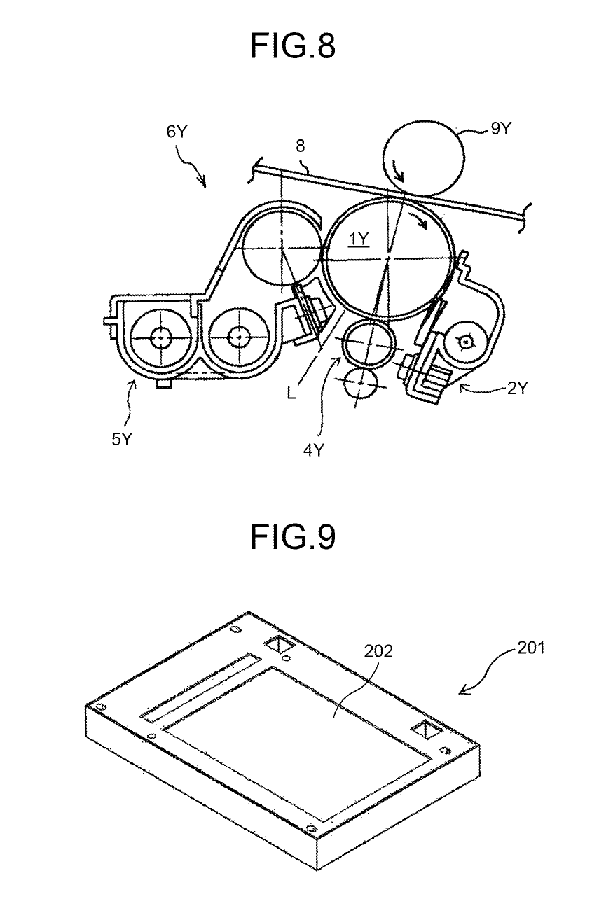

FIG. 7 is a schematic configuration diagram illustrating the copier according to the embodiment. The printer 100 includes four image forming units 6Y, 6M, 6C, and 6K that form toner images having colors of yellow, magenta, cyan, and black (hereinafter referred to as Y, M, C, and K, respectively), respectively. The four image forming units have the same configuration except that they use different colors of Y, M, C, and K toners as image forming material, and are replaced at the end of their respective lifetimes. For example, an image forming unit 6Y for forming a Y toner image includes a drum-like photosensitive element 1Y, a drum cleaning device 2Y, a neutralization device (not illustrated), a charging device 4Y, and a developing device 5Y as illustrated in FIG. 8. The image forming unit 6Y is removable from and mountable to the main body of the printer 100, thereby enabling consumable parts to be replaced all at once.

The charging device 4Y uniformly charges the surface of the photosensitive element 1Y that is rotated by a driving unit (not illustrated) clockwise in FIG. 8. The uniformly charged surface of the photosensitive element 1Y is subjected to exposure scanning by laser beams L emitted from an optical writing unit 7 serving as a latent image forming unit, so that the surface of the photosensitive element 1Y carries an electrostatic latent image for Y. The electrostatic latent image for Y is developed into a Y toner image by the developing device 5Y using Y toner. The Y toner image is intermediately transferred on an intermediate transfer belt 8. The drum cleaning device 2Y removes residual toner remaining on the surface of the photosensitive element 1Y after the intermediate transfer process. The neutralization device neutralizes residual electric charge remaining on the photosensitive element 1Y after the cleaning. This neutralization process initializes the surface of the photosensitive element 1Y and enables the photosensitive element 1Y to be prepared for the next image forming process. In the other image forming units 6M, 6C, and 6K, M, C, and K, toner images are formed on photosensitive elements 1M, 1C, and 1K, respectively, in the same manner as that in the image forming unit 6Y, and are intermediate-transferred on the intermediate transfer belt 8.

In FIG. 7, the optical writing unit 7 is mounted below the image forming units 6Y, 6M, 6C, and 6K. The optical writing unit 7 as the latent image forming unit irradiates the respective photosensitive elements in the image forming units 6Y, 6M, 6C, and 6K with the laser beams L emitted for exposure on the basis of image data. This exposure forms electrostatic latent images for Y, M, C, and K on the photosensitive elements 1Y, 1M, 1C, and 1K, respectively. The optical writing unit 7 irradiates the photosensitive elements with the laser beams L emitted from a light source via a plurality of optical lenses and mirrors while deflecting the laser beams L by using a polygon mirror that is rotationally driven by a motor in the main-scanning direction (in the axis direction of the photosensitive elements).

Below the optical writing unit 7, mounted are, for example, a sheet storage cassette 26 and a separating unit 27 installed thereto. The sheet storage cassette 26 stores therein a plurality of recording sheets P stacked as a sheet bundle. The separating unit 27 forms a separation nip with a feed roller 27a that can be driven rotationally and a separation pad 27b that contacts the feed roller 27a.

The feed roller 27a in the separating unit 27 contacts the uppermost recording sheet P of the sheet bundle in the sheet storage cassette 26. The feed roller 27a is rotationally driven to feed the recording sheet P into the separation nip. When a plurality of recording sheets P are fed into the separation nip in a stacking state, the feed roller 27a contacts the uppermost recording sheet P of the recording sheets thus fed. The uppermost recording sheet P follows the movement of the surface of the feed roller 27a to enter into the separation nip in the sheet feeding direction. To the rest of the recording sheets P below the uppermost recording sheet P, load resistance is applied by the separation pad 27b whose surface does not move. Thus, the recording sheets P below the uppermost recording sheet P cannot follow the uppermost recording sheet P to move in the sheet feeding direction, thereby staying in the separation nip. That is how the separating unit 27 separates the uppermost recording sheet P out of a plurality of recording sheets P fed out of the sheet storage cassette 26 and feeds the uppermost recording sheet P from the separation nip to a paper feed path. The recording sheet P thus fed out to the paper feed path passes through a pair of carriage rollers 28 (a roller 28a and a roller 28b) to a registration nip between a pair of registration rollers 29, where the recording sheet P is nipped therebetween and stops temporarily.

Above the image forming units 6Y, 6M, 6C, and 6K in FIG. 7, mounted is an intermediate transfer unit 15 that endlessly moves the intermediate transfer belt 8 looped in the intermediate transfer unit 15 in a tensioned state and serving as an intermediate transfer member. The intermediate transfer unit 15 is provided with, in addition to the intermediate transfer belt 8, four primary transfer bias rollers 9Y, 9M, 9C, and 9K, a cleaning device 10, and the like. The intermediate transfer unit 15 is also provided with a secondary transfer backup roller 12, a cleaning backup roller 13, a tension roller 14, and the rest.

The intermediate transfer belt 8 is looped over three rollers in a tensioned state and is endlessly moved counterclockwise in FIG. 7 by the rotational drive of at least one of the three rollers. The primary transfer bias rollers 9Y, 9M, 9C, and 9K nip the intermediate transfer belt 8 thus endlessly moved between the photosensitive elements 1Y, 1M, 1C, and 1K, respectively, and themselves to form primary transfer nips. Here, a method is implemented in which the primary transfer bias rollers 9Y, 9M, 9C, and 9K apply a transfer bias having a reversed polarity (for example, positive) to the polarity of toners to a surface inside the intermediate transfer belt 8 (internal circumference surface of a loop of the belt). All the rollers other than the primary transfer bias rollers 9Y, 9M, 9C, and 9K are electrically grounded. The Y, M, C, and K toner images on the photosensitive elements 1Y, 1M, 1C, and 1K are superimposed one by one onto the intermediate transfer belt 8 that sequentially passes through the primary transfer nips for Y, M, C, and K along with the endless movement. Thereby, a toner image of four superimposed colors (hereinafter referred to as a “four-color toner image”) is formed on the intermediate transfer belt 8.

The secondary transfer backup roller 12 mounted inside the loop of the belt nips the intermediate transfer belt 8 between a secondary transfer roller 19 and itself to form a secondary transfer nip. The recording sheet P, which was nipped at the registration nip between the pair of registration rollers 29 and stopped temporarily, is fed to the secondary transfer nip at a timing at which the recording sheet P is synchronized with the four-color toner image on the intermediate transfer belt 8. The four-color toner image is secondarily transferred in the secondary transfer nip.

Residual post-transfer toner that has not been transferred to the recording sheet P remains on the surface of the intermediate transfer belt 8 that has passed through the secondary transfer nip. This residual post-transfer toner is removed by the belt cleaning device 10.

When the recording sheet P fed out of the secondary transfer nip passes through rollers in a fixing device 20, heat and pressure are applied, so that the four-color toner image transferred on the surface of the recording sheet P is fixed. Then, the recording sheet P passes through a pair of ejecting rollers 30 to be ejected out of the copier. At the top of the main body of the printer, formed is a stacking part 31 on which the recording sheet P ejected by the pair of ejecting rollers 30 out of the copier is stacked one by one.

Between the intermediate transfer unit 15 and the stacking part 31 placed thereabove, mounted is a bottle container 33. The bottle container 33 stores therein toner bottles 32Y, 32M, 32C, and 32K that contain the Y, M, C, and K toners, respectively, and that serve as a replenishment-toner storage part. The toner bottles 32Y, 32M, 32C, and 32K are set in the bottle container 33 in a manner in which each of the toner bottles are put in from above. The Y, M, C, and K toners in the toner bottles 32Y, 32M, 32C, and 32K are supplied as appropriate to the developing devices of the image forming units 6Y, 6M, 6C, and 6K by a toner replenishment device (not illustrated). The toner bottles 32Y, 32M, 32C, and 32K can be mounted to and removed from the main body of the printer 100 independently of the image forming units 6Y, 6M, 6C, and 6K.

Near the fixing device 20, a reversing device is mounted. In a duplex printing mode in which images are formed on both surfaces of the recording sheet P, the recording sheet P passes through the fixing device 20 after a toner image is formed on one surface thereof, and is flipped over by the reversing device to be sent to the registration nip between the pair of registration rollers 29 (roller 29a and roller 29b) again. The recording sheet P is then fed from the registration nip to the secondary transfer nip, where another toner image is formed on the other surface of the recording sheet P. Then, the recording sheet P is subjected to the fixing process for the toner image on the other surface thereof at the fixing device 20, ejected by the pair of ejecting rollers 30, and is stacked on the stacking part 31.

In FIG. 7, a front view of the copier according to the embodiment is illustrated. On the top of the printer 100, mounted is the image reading unit 200 that includes the scanner 201 and the ADF 251. The image reading unit 200 is fixed on a stand 299 supported by two legs fixed on the back side of the printer 100. A large space is provided between the stacking part 31 of the printer 100 and the stand 299. Recording sheets P stacked on the stacking part 31 are placed in the space.

The scanner 201 of the image reading unit 200 includes an integrated scanning optical unit 203. The integrated scanning optical unit 203 is disposed immediately below an exposure glass that is fixed on the upper wall of a casing of the scanner 201 so as to be in contact with a document MS, and can move an optical system including a light source and reflecting mirrors in right and left directions in FIG. 7. While the optical system travels from left to right in FIG. 7, light emitted from the light source is reflected on a document (not illustrated) placed on the exposure glass. Then, after being reflected on the reflecting mirrors, the light is received by an image sensor.

FIG. 9 is a perspective view illustrating the scanner 201. Although not illustrated in FIG. 9 for the convenience of explanation, the ADF 251 (not illustrated) is mounted on the top of the scanner 201 and is supported by hinges in a swingable manner so that the top surface of the scanner 201 can be opened and closed. On the top surface of the scanner 201, mounted is an exposure glass 202 on which a document (not illustrated) is set.

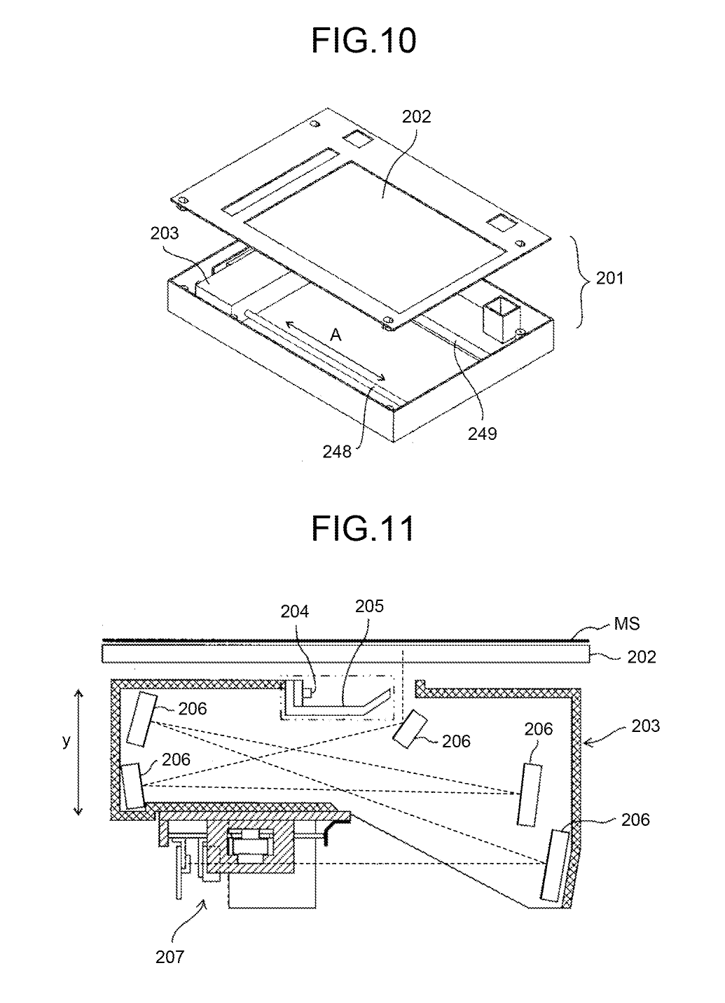

FIG. 10 is an exploded perspective view illustrating the scanner 201. Inside the scanner 201, disposed are the integrated scanning optical unit 203 that reads a document through optical scan, a guide rod 248 that movably retains the integrated scanning optical unit 203 in a sub-scanning direction (in the direction of arrow A in FIG. 10), a guide rail 249, and the rest.

FIG. 11 is an enlarged configuration diagram illustrating the integrated scanning unit 203 in an enlarged scale. The integrated scanning unit 203 includes a light source 204 that emits light to irradiate the document MS on the exposure glass 202, a reflecting plate 205 that reflects the light emitted from the light source 204 to the document MS, and an image capturing unit part 207. The integrated scanning unit 203 also includes a plurality of reflecting mirrors 206 that sequentially reflect the light reflected on a document surface of the document MS to forward the light to the image capturing unit part 207. The light reflected on the document surface of the document MS is reflected on the reflecting mirrors 206 and is finally received by the image capturing unit part 207.

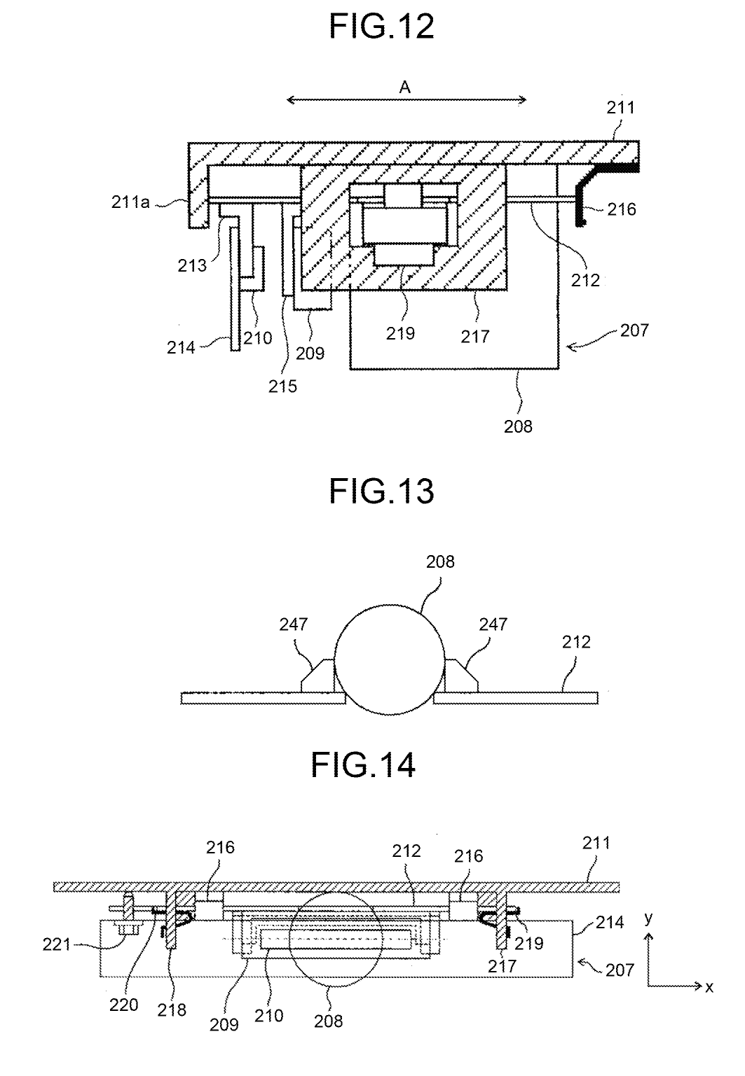

FIG. 12 is an enlarged configuration diagram illustrating an image capturing unit device including the image capturing unit part 207. The image capturing unit part 207 of the image capturing unit device is supported by a unit supporting plate 211. The image capturing unit device includes a first lens group 208, a second lens 209, an image sensor 210, a holding plate 212, a sensor bracket 213, a sensor substrate 214, a second lens bracket 215, biasing plate springs 216, and the rest.

The unit supporting plate 211 is fixed on the bottom surface of the integrated scanning unit 203. On a part mounting surface (a surface facing down in the vertical direction) of the unit supporting plate 211, fixed are a first bracket 217 for the supporting plate and the biasing plate springs 216. Although not illustrated in FIG. 12 because of being hidden by the first bracket 217 for the supporting plate, a second bracket (218 of FIG. 14 to be described later) for the supporting plate positioned behind the first bracket 217 is fixed on the unit supporting plate 211.

The holding plate 212 holds the first lens group 208, the second lens 209, the image sensor 210, and the rest. The first lens group 208 includes a plurality of first lenses (not illustrated) held in a lens holding member having a cylindrical shape. As illustrated in FIG. 13, the first lens group 208 is fixed by adhesion materials 247 in the holding plate 212 with a part of the first lens group 208 being outside of the holding plate 212 through an opening disposed therein. As illustrated in FIG. 12, the part of the first lens group 208 being outside of the holding plate 212 contacts the unit supporting plate 211. The first lens group 208 may be fixed in the holding plate 212 by a band or the like, not by the adhesion materials 247.

The second lens 209 is fixed on the second lens bracket 215 standing on the part mounting surface of the holding plate 212. The image sensor 210 is fixed on the sensor substrate 214, and the sensor substrate 214 is fixed on the sensor bracket 213 standing on the part mounting surface of the holding plate 212.

The holding plate 212 is pushed against a positioning protrusion part 211a formed on the unit supporting plate 211 by a biasing power by the biasing plate springs 216, whereby a position of the holding plate 212 in the sub-scanning direction (in the direction of arrow A in FIG. 12) is determined. The reflected light (not illustrated) received in the image capturing unit part 207 is received by the image sensor 210 after passing through the first lens group 208 and the second lens 209 in this order. For the image sensor 210, a sensor constituted by CCD, CMOS, or the like is used.

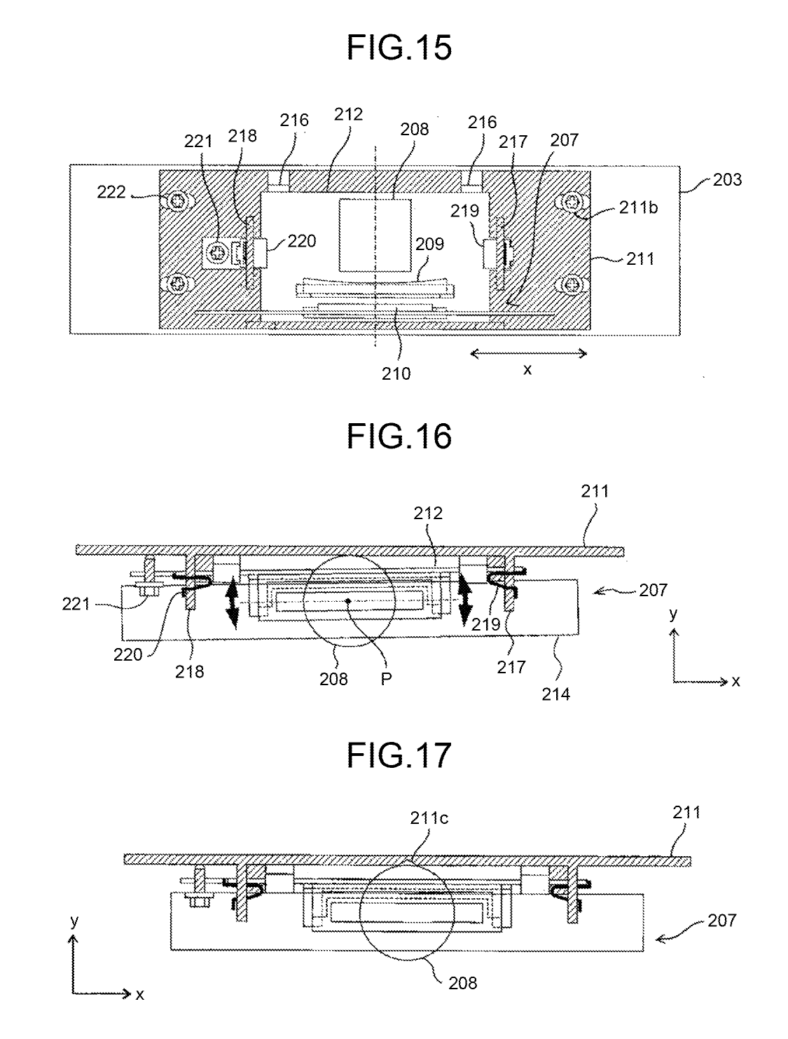

FIG. 14 is a front view illustrating the image capturing unit device. FIG. 15 is a plan view illustrating the image capturing unit device. FIG. 15 is a view seen from below the image capturing unit device by looking up in the vertical direction. In FIGS. 14 and 15, a first tilt adjustment plate spring 219 is fixed at a first end of the holding plate 212 of the image capturing unit part 207 in the image capturing unit device in the main-scanning direction (in the direction of arrow X in FIGS. 14 and 15), and a second tilt adjustment plate spring 220 is fixed at a second end in the main-scanning direction thereof.

In FIG. 12, the first bracket 217 for unit support that supports the image capturing unit part 207 is provided with an opening. The first tilt adjustment plate spring 219 is inserted into the opening in a manner in which the spring presses the inner wall of the opening. With this arrangement, the first end of the holding plate 212 in the main-scanning direction is supported by the first bracket 217 for unit support. Although not illustrated in FIG. 12, the second tilt adjustment plate spring (220) is also inserted into an opening of the second bracket for unit support in a manner in which the spring presses the inner wall of the opening. With this arrangement, the second end of the holding plate 212 in the main-scanning direction is supported by the second bracket for unit support.

As illustrated in FIG. 15, elongate holes 211b each elongated in the main-scanning direction (in the direction of arrow X) are provided in the vicinity of the four corners of the unit supporting plate 211 having a rectangular shape. Fixing screws 222 are each screwed, through the elongate holes 211b, into female screws in a casing of the integrated scanning unit 203, thereby fixing the unit supporting plate 211 on the integrated scanning unit 203. Loosening the fixing screws 222 enables the unit supporting plate 211 to move along the elongate holes 211a in the main-scanning direction, thereby enabling the positioning of the image capturing unit part 207 in the main-scanning direction.

In FIG. 11, the integrated scanning unit 203 is held by the guide rod (not illustrated, refer to reference numeral 248 in FIG. 10) and the guide rail (not illustrated, refer to reference numeral 246 in FIG. 10) through height adjustment screws (not illustrated). Turning the height adjustment screws enables the positioning of the integrated scanning unit 203 in the scanner in the height direction thereof. This height adjustment sets the position in the “sub-scanning direction in an optical scanning system” of the image capturing unit part 207. Although the sub-scanning direction of the scanner 201 is the direction in which the integrated scanning unit 203 travels (in right and left direction in FIG. 11), the “sub-scanning direction in an optical scanning system” of the image capturing unit part 207 is the direction of arrow y in FIG. 11. This is because moving the image capturing unit part 207 in the direction of arrow y in FIG. 11 causes the position read by optical scanning to be shifted in the right and left direction (the sub-scanning direction of the scanner) in FIG. 11.

In FIG. 14, when an operator performs the positioning of the image capturing unit part 207 in the x-y plane, first, the operator moves the image capturing unit part 207 in the x direction and the y direction. With this operation, the center of the lens in the first lens group 208 in the image capturing unit part 207 is positioned in target coordinates in the x-y plane. The position of the image capturing unit part 207 in the sub-scanning direction (in the direction of arrow x) is adjusted by loosening the fixing screws 222 illustrated in FIG. 15. The position of the integrated scanning unit 203 in the direction of arrow y in FIG. 11 is adjusted by turning the height adjustment screws in the integrated scanning unit 203 in FIG. 11.

Then, as illustrated in FIG. 16, the operator turns a tilt adjustment screw 221 that is screwed into the holding plate 212. The tip of the tilt adjustment screw 221 abuts on a surface of the unit supporting plate 211. Turning the tilt adjustment screw 221 changes the distance between the second end of the holding plate 212 in the main-scanning direction (x direction) and the unit supporting plate 211. This changes an amount of contraction of the second tilt adjustment plate spring 220 fixed at the second end of the holding plate 212. Accordingly, the ratio of the amount of contraction in the second tilt adjustment plate spring 220 to that of the first tilt adjustment plate spring 219 fixed at the first end of the holding plate 212 changes, thereby changing the tilt angle of the image capturing unit part 207 as indicated by bold arrows in FIG. 16.

In FIG. 16, the unit supporting plate 211, the holding plate 212, the first bracket 217 for unit support, the second bracket 218 for unit support, the first tilt adjustment plate spring 219, the second tilt adjustment plate spring 220, the tilt adjustment screw 221, and the first lens group 208 constitute a tilt adjustment mechanism that adjusts the tilt in the image capturing unit part 207 on the x-y plane. The tilt adjustment mechanism can adjust the tilt in the image capturing unit part 207 on the x-y plane by rotation of the image capturing unit part 207 about the center of the first lens (the point P in FIG. 16) in the first lens group 208 thereof.

In the image capturing unit part 207 after tilt correction performed by the tilt adjustment mechanism, the center (point P) of the first lens (imaging lens) in the first lens group 208 is placed in the target coordinates on the x-y plane. In addition, all the parts in the image capturing unit part 207 are placed in respective target coordinates, thereby completing the positioning of the entire image capturing unit part 207. As described above, in the copier according to the embodiment, the positioning of the entire image capturing unit part 207 can be completed by only two operation processes: one is a process of positioning the center of the first lens in the image capturing unit part 207 at target coordinates, and the other one is a process of correcting the tilt in the image capturing unit part 207 with the tilt adjustment mechanism. Compared with the number of operation processes required in the conventional procedure, which are three, the number of operation processes in the embodiment is smaller by one; thereby facilitating the assembling procedure of the image capturing unit part 207 compared with the conventional assembling procedure.

Following is a description of an example of the copier according to the embodiment to which a configuration having a more particular feature is added.

FIG. 17 is a front view illustrating the image capturing unit part 207 in an example of the copier according to the embodiment. In the first lens group 208, the outer circumference surface of the lens holding member having a cylindrical shape is a curved surface curving at a predetermined curvature about the center of the first lens serving as the imaging lens. On a surface of the unit supporting plate 211, formed is a concave part 211c that receives a part of the curved surface. When the tilt adjustment mechanism adjusts the tilt in the image capturing unit part 207, the lens holding member of the first lens group 208 rotates with the outer circumference surface of the lens holding member abutting to the edges of the concave part 211c. This abutting prevents the first lens group 208 from slipping in the main-scanning direction (in the direction of arrow x) on the surface of the unit supporting plate 211. Preventing the slip of the first lens group 208 enables the image capturing unit part 207 to be rotated about the center of the first lens more accurately.

The above description is an example, and the present invention attains a particular effect for each of the aspects below.

Aspect A. Aspect A provides a tilt adjustment mechanism installed in an optical device (the scanner 201, for example) that captures an image by using an image capturing unit part (the image capturing unit part 207, for example) in which an image capturing sensor (the image sensor 210, for example) to capture an image and an imaging lens (the first lens in the first lens group 208, for example) to image an image on the image capturing sensor are mounted on a holding member (the holding plate 212, for example) to constitute a unit part, in which tilt adjustment of the image capturing unit part is enabled by rotation of the image capturing unit part about the center of the imaging lens (the point P, for example).

Aspect B. Aspect B provides an image capturing unit device including an image capturing unit part in which an image capturing sensor to capture an image and an imaging lens to image an image on the image capturing sensor are mounted on a holding member to constitute a unit part, and including a tilt adjustment mechanism to adjust tilt in the image capturing unit part, in which the tilt adjustment mechanism according to aspect A is installed as the tilt adjustment mechanism.

Aspect C. According to aspect C, in aspect B, a supporting member (the unit supporting plate 211, for example) that supports the holding member is provided, and the tilt adjustment mechanism is configured to rotate the holding member on the supporting member about the center of the imaging lens held by the holding member. In this configuration, the tilt in the image capturing unit part can be adjusted by rotation of the holding member on the supporting member.

Aspect D. According to aspect D, in aspect C, the holding member or a held member (the lens holding member of the first lens group 208) that is held by the holding member has a curved surface (the outer circumferential surface of the lens holding member having a cylindrical shape of the first lens group 208, for example) curving at a predetermined curvature about the center of the imaging lens; the supporting member has a concave part (the concave part 211a, for example) that partly receives the curved surface; and the tilt adjustment mechanism is configured to rotate the holding member about the axis with the curved surface sliding against the concave part. In this configuration, as described above, preventing the holding member or the held member from slipping on a surface of a first holding member in the x direction enables the image capturing unit part to be rotated on the x-y plane about the center of the imaging lens more accurately.

Aspect E. According to aspect E, in aspect D, the imaging lens includes a first lens group (the first lens group 208, for example) that is arranged in line in a holder member (the lens holding member of the first lens group 208) having a cylindrical shape in the direction of the axis of the cylindrical shape and held by the holder member, and a second lens (the second lens 209, for example) that receives reflected light after passing through the first lens group, and the curved surface is the outer circumference surface of the holder member held by the holding member. In this configuration, the curved surface of the holder member is used as a curved surface that slides against the concave part of the supporting member and curves about the center of the lens, thereby avoiding a cost increase caused by providing a dedicated curved surface.

Aspect F. Aspect F provides an image scanning device (the integrated scanning device 203, for example) as an optical device that scans an image on a document to read the image by using an image capturing unit device including an image capturing unit part in which an image capturing sensor to capture an image and an imaging lens to image an image on the image capturing sensor are mounted on a holding member to constitute a unit part, and including a tilt adjustment mechanism to adjust tilt in the image capturing unit part, and by using a light source that emits light to irradiate an image surface on the document, in which the image capturing unit device according to any one of aspects A to E is used as the image capturing unit device.

Aspect G. Aspect G provides an image reading device (the scanner 201, for example) that reads an image on a document by using an image scanning unit that scans the image on the document and a document holding unit (the exposure glass 202, for example) that holds the document at an image scanning position in the image scanning unit, in which the image scanning device according to claim 6 is used as the image scanning unit.

Aspect H. Aspect H provides a copier that includes an image reading unit to read an image on a document and an image forming unit (the printer 100, for example) to form an image on a recording member, forms the image read by the image reading unit on the recording member by using the image forming unit, and copies the image, in which the image reading device according to claim 7 is used as the image reading unit.

The present invention can facilitate the assembling procedure of an image capturing unit part compared with the conventional procedure by way of the following operation processes. An image capturing unit part is moved in the x direction and the y direction on the x-y plane, and the center of an imaging lens of the image capturing unit part is positioned in target coordinates. If the image capturing unit part thus positioned is not tilted, all the parts in the image capturing unit part, let alone the center of the imaging lens, are positioned in the respective target coordinates, thereby completing the positioning of the entire image capturing unit part. In most cases, however, it frequently happens that the image capturing unit part is not in a proper position but tilted, that is, only the center of the imaging lens of the image capturing unit part is positioned in the target coordinates, but the other parts are deviated from the respective target coordinates. To correct the tilt in the image capturing unit part, a tilt adjustment mechanism is used. This tilt adjustment mechanism can adjust the tilt in the image capturing unit part by rotation of the image capturing unit part about the center of the imaging lens. This tilt adjustment mechanism can correct the tilt in the image capturing unit part without moving its position on the x-y plane by rotation of the image capturing unit part about the center of the imaging lens. In the image capturing unit part after tilt correction, the center of the imaging lens is positioned in the target coordinates, and all the parts of the image capturing unit part are also positioned in the respective target coordinates, thereby completing the positioning of the entire image capturing unit part. In the present invention, as described above, the entire image capturing unit part can be properly positioned by implementing two operation processes: one is a process of positioning the center of the imaging lens in the image capturing unit part in the target coordinates, and the other is a process of correcting the tilt in the image capturing unit part with the tilt adjustment mechanism. The present invention eliminates the need for one more process of the re-positioning of the image capturing unit part, which is required in the conventional procedure, thereby facilitating the assembling procedure of the image capturing unit part compared with the conventional procedure.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A tilt adjustment mechanism that is installed in an optical device that captures an image by using an image capturing unit part in which an image capturing sensor to capture an image and an imaging lens to image an image on the image capturing sensor are mounted on a holding member to constitute a unit part, and that is configured to adjust tilt of the image capturing unit part by rotating the image capturing unit part about the center of the imaging lens.

2. An image capturing unit device comprising:
an image capturing unit part in which an image capturing sensor to capture an image and an imaging lens to image an image on the image capturing sensor are mounted on a holding member to constitute a unit part; and
a tilt adjustment mechanism configured to adjust tilt of the image capturing unit part by rotating the image capturing unit part about the center of the imaging lens.

3. The image capturing unit device according to claim 2, further comprising:
a supporting member configured to support the holding member, wherein
the tilt adjustment mechanism is configured to rotate the holding member on the supporting member about the center of the imaging lens held by the holding member.

4. The image capturing unit device according to claim 3, wherein
the holding member or a held member that is held by the holding member has a curved surface curving at a predetermined curvature about the center of the imaging lens,
the supporting member has a concave part that partly receives the curved surface, and
the tilt adjustment mechanism is configured to rotate the holding member about the axis with the curved surface sliding against the concave part.

5. The image capturing unit device according to claim 4, wherein
the imaging lens includes a first lens group that is arranged in line in a holder member having a cylindrical shape in the direction of the axis of the cylindrical shape and held by the holder member, and a second lens that receives reflected light after passing through the first lens group, and
the curved surface is the outer circumference surface of the holder member held by the holding member.

6. An image scanning device that scans an image on a document for reading the image, the image scanning device comprising:
a light source configured to irradiate an image surface on the document with emitted light thereof;
an image capturing unit part in which an image capturing sensor to capture an image and an imaging lens to image an image on the image capturing sensor are mounted on a holding member to constitute a unit part, and
a tilt adjustment mechanism configured to adjust tilt of the image capturing unit part by rotating the image capturing unit part about the center of the imaging lens.

7. An image reading device that reads an image on a document by using an image scanning unit that scans the image on the document and a document holding unit that holds the document at an image scanning position in the image scanning unit, wherein
the image scanning device according to claim 6 is used as the image scanning unit.

8. A copier that includes an image reading unit configured to read an image on a document, and an image forming unit configured to form an image on a recording member, and the copier forms the image read by the image reading unit on the recording member by using the image forming unit and copies the image, wherein
the image reading device according to claim 7 is used as the image reading unit.
